(19) United States
(12) Patent Application Publication
(10) Pub. No.: US 2002/0081426 A1
(43) Pub. Date: Jun. 27, 2002

(54) Sheet material and pressure-sensitive adhesive sheet containing the same

(75) Inventors: Shinji Inokuchi, Osaka (JP); Naoyuki Nishiyama, Osaka (JP); Takahiro Nonaka, Osaka (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Nitto Denko Corporation, Ibaraki-shi (JP)

(21) Appl. No.: 10/007,742

(22) Filed: Nov. 8, 2001

(30) Foreign Application Priority Data
Nov. 9, 2000 (JP) 342521/2000

(51) Int. Cl. B32B 7/06; B32B 27/36

(52) U.S. Cl. 428/343; 428/483; 428/523

(57) ABSTRACT

The present invention provides a pressure-sensitive adhesive sheet having superior release properties of a sheet material and a pressure-sensitive adhesive layer, and a sheet material having a release function suitable for the sheet. The present invention provides a single layer or laminate sheet material having a release function for a pressure-sensitive adhesive sheet, wherein the sheet material itself when it is a single layer, and at least one of the outermost layers when it is a laminate, is made from a resin material containing a linear ethylene resin as a main component, and the resin material shows an amount of an eluted component at not more than 30° C. of 3 wt %−30 wt % of the entire resin material, as measured by a Temperature Rising Elution Fractionation, and a pressure-sensitive adhesive sheet that uses the sheet material.

### FIELD OF THE INVENTION

The present invention relates to a sheet material suitable as a material of a pressure-sensitive adhesive sheet and a pressure-sensitive adhesive sheet containing the sheet material. In the present specification, the sheet material and the pressure-sensitive adhesive sheet respectively encompass a tape material and a pressure-sensitive adhesive tape.

### BACKGROUND OF THE INVENTION

Pressure-sensitive adhesive sheets comprise a sheet material consisting only of a layer made by curing a release agent or a releasable sheet material having this layer as the outermost layer, and a pressure-sensitive adhesive layer in contact with the sheet material, wherein the sheet material and the pressure-sensitive adhesive layer can be released from each other. The aforementioned sheet material can be formed by curing only a release agent or by applying a release agent to a side of a release sheet substrate intended to be in contact with at least a pressure-sensitive adhesive layer, and curing the agent. As the aforementioned release agent, for example, silicone release agents are known. A pressure-sensitive adhesive layer is formed from, for example, an acrylic pressure-sensitive adhesive and comes into contact with a sheet material.

In such pressure-sensitive adhesive sheet, a silicone compound contained in the sheet material adheres to the pressure-sensitive adhesive layer when the sheet material is peeled off from the pressure-sensitive adhesive layer. A pressure-sensitive adhesive layer, to which a silicone compound is adhered, shows markedly decreased adhesive property when compared to a pressure-sensitive adhesive layer without a silicone compound.

When the aforementioned pressure-sensitive adhesive sheet is used to fix devices of electronic equipment, there generally occur easily corrosion inside the electronic equipment and malfunction of electronic equipment. Such corrosion and malfunction occur particularly easily when the aforementioned sheet is used inside the electronic equipment such as hard disc drive (HDD). This is considered to be caused by the generation of siloxane gas by a silicone compound adhered to a pressure-sensitive adhesive layer upon release of a sheet material from the pressure-sensitive adhesive layer.

JP-B-51-20205 discloses a sheet material formed by the use of a release agent other than silicone compounds. This sheet material contains a low density polyethylene resin as a release agent. This sheet material is formed by laminating the low density polyethylene resin on a release sheet substrate while suppressing oxidation of the surface.

Furthermore, U.S. Pat. Nos. 4,339,485 and 4,425,176 disclose sheet materials formed by laminating a release agent other than silicone compounds on a release sheet substrate. In this sheet material, a resin mixture of a low density polyethylene resin and an ethylene-propylene copolymer or a resin mixture of a low density polyethylene resin and an ethylene-1-butene random copolymer is used as a release agent.

A pressure-sensitive adhesive sheet comprising such a sheet material and a pressure-sensitive adhesive layer shows lower release property when a pressure-sensitive adhesive layer has a relatively high adhesive strength. A pressure-sensitive adhesive sheet having decreased release property is associated with adhesion of an adhesive to a sheet material upon release of a pressure-sensitive adhesive layer from a sheet material, or undesirable release called stick slip wherein the surface of a pressure-sensitive adhesive layer after release becomes undulate. As a result, the pressure-sensitive adhesive layer exposed by the release thereof from the sheet material comes to have a greater surface roughness. Such a pressure-sensitive adhesive sheet cannot fully exhibit the adhesive strength that a pressure-sensitive adhesive layer inherently has, resulting in poor adhesion.

When a resin mixture of a low density polyethylene resin and an ethylene-propylene copolymer or a resin mixture of a low density polyethylene resin and an ethylene-1-butene random copolymer is used, there arises, besides the aforementioned problems, a problem in that plural steps to mix resins are necessary to obtain a resin mixture, which in turn increases the production cost.

The present invention solves the above-mentioned problems and aims at providing a pressure-sensitive adhesive sheet showing superior release property of a sheet material from a pressure-sensitive adhesive layer, and a sheet material having a release function suitable for the sheet.

### SUMMARY OF THE INVENTION

According to the present invention, the following are provided.

(1) A single layer or laminate sheet material having a release function for a pressure-sensitive adhesive sheet, wherein the sheet material itself when it is a single layer, and at least one of the outermost layers when it is a laminate, is made from a resin material comprising a linear ethylene resin as a main component, and the resin material shows an amount of an eluted component at not more than 30° C. of 3 wt %-30 wt % of the entire resin material, as measured by a Temperature Rising Elution Fractionation method.

(2) The sheet material of the above-mentioned (1), wherein the above-mentioned linear ethylene resin is a copolymer of ethylene and at least one kind of a comonomer selected from α-olefins having 3 to 12 carbon atoms.

(3) A pressure-sensitive adhesive sheet comprising the sheet material of the above-mentioned (1) or (2) and a pressure-sensitive adhesive layer formed to be in contact with the sheet material itself when it is a single layer or, when it is a laminate, with at least an outermost layer thereof made from a resin material comprising a linear ethylene resin as a main component.

(4) The pressure-sensitive adhesive sheet of the above-mentioned (3), wherein the pressure-sensitive adhesive layer is formed using, as a main component, a polyester adhesive comprising aliphatic polycarbonate diol as an essential polyol component.

### DETAILED DESCRIPTION OF THE INVENTION

The present invention is described in detail in the following.

The sheet material for a pressure-sensitive adhesive sheet of the present invention may be a single layer or a laminate. When it is a single layer, the sheet material itself is made from a specific resin material comprising a linear ethylene resin to be mentioned later as a main component, and when it is a laminate, at least one of the outermost layers is made from a specific resin material comprising a linear ethylene resin to be mentioned later as a main component.

According to the present invention, a resin material to be used shows an amount of an eluted component at not more than 30° C., as measured by a Temperature Rising Elution Fractionation method, of 3 wt %-30 wt %, preferably 4 wt %-15 wt %, of the entire resin material. When the amount of the eluted component is less than 3 wt % of the entire resin material, the sheet material is not released easily from the pressure-sensitive adhesive layer, thereby preventing fine release performance. When the amount of the eluted component exceeds 30 wt % of the entire resin material, the sheet material becomes too soft to maintain the shape or becomes poor in heat resistance.

The Temperature Rising Elution Fractionation method to be used in the present invention is as follows. The above-mentioned resin material is dissolved in o-dichlorobenzene at a temperature (e.g., 140° C.), at which the resin material dissolves completely, and cooled at a certain rate (1° C./min) to −10° C. to form a thin polymer layer in a TREF column packed with glass beads (inert carrier). In this case, a layer of easily crystallized polymer (a high crystallinity component) is formed first and thereafter, a low crystallinity or a non-crystalline component polymer layer, which is difficult to crystallize, is formed. The resulting layers are maintained at −10° C. for 60 minutes thereafter, and the temperature is raised stepwise while o-dichlorobenzene is flown as a mobile phase in the column at a flow rate of 1 ml/min. The result is that, conversely from the cooling, a low crystallinity or a non-crystalline component elutes out first and then a high crystallinity component elutes out. The composition distribution of the resin material is analyzed from the amount of the eluted component at each temperature and the elution curve depicted according to the elution temperature. The apparatus with which to apply the above-mentioned Temperature Rising Elution Fractionation method is conventionally known, such as Cross Fractionation Chromatographic apparatus (CFC T-150A, MITSUBISHI CHEMICAL CORPORATION) and the like.

The resin material to be used in the present invention may be made from a linear ethylene resin or a mixture of a linear ethylene resin as a main component and other resin components or additives. When the resin material is a mixture, the aforementioned resin component and the additive are added in an amount that does not impair the release function, film forming property, resistance to solvent and heat resistance that the linear ethylene resin imparts to the sheet material. In the present invention, the content of the linear ethylene resin in a layer containing the linear ethylene resin is 50-100%, preferably 70-100%.

The resin material to be used in the present invention can be obtained according to a known method by appropriately determining the copolymerization conditions, purification conditions and separation conditions. Alternatively, a commercially available product may be used.

The sheet material of the present invention imparts a suitable release function to a pressure-sensitive adhesive sheet based on superior release property from a pressure-sensitive adhesive layer, because the sheet material itself or the outermost layer of the sheet material is made from a specific resin material comprising a linear ethylene resin as a main component. Even when the pressure-sensitive adhesive layer of the sheet material of the present invention has a relatively high adhesive strength, adhesion of an adhesive to a sheet material upon release of a pressure-sensitive adhesive layer from a sheet material, or undesirable release such as stick slip, due to decreased release property, does not occur. Therefore, the pressure-sensitive adhesive layer exposed after release has a suitable surface roughness and the pressure-sensitive adhesive layer can exhibit sufficient adhesive strength.

In the present specification, by being “superior in release property” is meant adhesion of the pressure-sensitive adhesive layer to the sheet material measured according to the measurement method defined in JIS Z-0237 using, for example, a conventionally known universal tensile strength tester, in other words, peeling strength from the sheet material within the range of 0.05 N/20 mm width-0.80 N/20 mm width, preferably 0.10 N/20 mm width-0.50 N/20 mm width. When the peeling strength is less than 0.05 N/20 mm width, the sheet material may be undesirably released from the pressure-sensitive adhesive layer before use, or partially come off from the pressure-sensitive adhesive layer. When the peeling strength exceeds 0.80 N/20 mm width, the release of the sheet material from the pressure-sensitive adhesive layer may become difficult during use, or discontinuous release, so-called stick slip, may occur.

The linear ethylene resin, which is the main component of the resin material in the present invention, is not particularly limited, but is preferably a copolymer of, for example, at least one kind of comonomer selected from a-olefins having 3 to 12 carbon atoms, such as propylene, 1-butene, 1-hexene, 4-methyl-1-pentene and 1-octene, and ethylene, and particularly preferably ethylene-1-butene copolymer, ethylene-4-methyl-1-pentene copolymer, ethylene-1-hexene copolymer or ethylene-1-octene copolymer.

Using a resin material comprising the above-mentioned linear ethylene resin as a main component, the resin material can be obtained through less number of steps, as compared to the use of a conventional resin mixture of low density polyethylene and an ethylene-propylene copolymer or an ethylene-1-butene random copolymer, and a sheet material having a superior release function can be produced more easily and at a lower cost.

The sheet material of the present invention is produced by forming a release sheet from the aforementioned resin material by a known forming method, such as extrusion method. The release sheet has a thickness appropriately determined according to the use thereof, which is, for example, 30 μm-300 μm. When the sheet material is a single layer, the release sheet is used as it is as a sheet material.

The sheet material of the present invention may comprise a layer made of the above-mentioned resin material laminated on at least one side of the release sheet substrate. The laminate sheet material is obtained by laminating the above-mentioned resin material on at least one side of the release sheet substrate by a known laminating method such as extrusion lamination, dry lamination, wet lamination, hot melt lamination and the like. The laminate sheet material has a thickness appropriately determined according to the use thereof, which is, for example, 30 μm-300 μm.

Examples of the release sheet substrate include plastic film, metal foil and paper. Examples of the plastic film include those made from high density polyethylene, low density polyethylene, linear low density polyethylene, nylon, polyester, polypropylene, poly-4-methyl-1-pentene, polystyrene, polyvinyl chloride and the like. Examples of the metal foil include aluminum foil and stainless foil. Examples of the paper include Japanese paper, kraft paper, woodfree paper and crepe paper. The release sheet substrate may be one mentioned above, which may be used solely or a laminate of those mentioned above in combination.

A pressure-sensitive adhesive sheet comprising the sheet material of the present invention comprises a pressure-sensitive adhesive layer formed to be in contact with the sheet material itself when it is a single layer, or at least one of the outermost layers, when it is a laminate. The pressure-sensitive adhesive layer is formed by applying a solution, emulsion or hot melt pressure-sensitive adhesive (for example, by direct application and drying) on one surface of a sheet material when it is a single layer, and on an outermost layer of the sheet material, when it is a laminate. The pressure-sensitive adhesive layer is formed to make the thickness 1 μm-70 μm, preferably 20 μm-50 μm.

The pressure-sensitive adhesive to be the main component of the pressure-sensitive adhesive layer is not particularly limited, and a preferable example is a polyester polymer comprising aliphatic polycarbonate diol as an essential polyol component. The aliphatic polycarbonate diol is a diol having an aliphatic polycarbonate structure having a repeat unit of the following formula

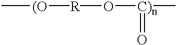

wherein R is a linear or branched chain hydrocarbon group having 2-20 carbon atoms.

Such diol can be obtained by, for example, the reaction of a diol component such as butanediol and a carbonate compound such as ethylene carbonate. The aforementioned polyester polymer having a weight average molecular weight of preferably not less than 10,000, more preferably not less than 30,000 (generally not less than 300,000) is used. By forming a pressure-sensitive adhesive layer using, as a main component, a polyester pressure-sensitive adhesive comprising an aliphatic polycarbonate diol as an essential polyol component, the release property between a sheet material and a pressure-sensitive adhesive layer can be further improved.

The aforementioned polyester pressure-sensitive adhesive can be prepared by adding various additives as necessary to the aforementioned diol having an aliphatic polycarbonate structure.

In the pressure-sensitive adhesive to be used in the present invention, the polyol component is preferably, but not limited to, the above-mentioned aliphatic polycarbonate diol. For example, the polyol component may have a linear diol component such as ethylene glycol, propylene glycol, butanediol, pentanediol, hexanediol, heptanediol, octanediol, decanediol and octadecanediol.

The polybasic acid component to be reacted with the diol component is preferably one having an aliphatic or alicyclic hydrocarbon group having 2-20 carbon atoms as a molecular skeleton. The aliphatic hydrocarbon group may be linear or a branched chain. Examples of the polybasic acid component include malonic acid, succinic acid, methylsuccinic acid, adipic acid, sebacic acid, 1,2-decanedioic acid, 1,14-tetradecanedioic acid, n-hexyladipic acid, tetrahydrophthalic acid, endomethylenetetrahydrophthalic acid, and derivatives thereof such as acid anhydride and ester.

Examples of the pressure-sensitive adhesive to be preferably used in the present invention include, besides the aforementioned polyester pressure-sensitive adhesive having a polyol component, polyacrylate pressure-sensitive adhesive containing a polyacrylate and/or polymethacrylate. The polyacrylate pressure-sensitive adhesive mainly contains an acrylic polymer obtained by polymerization generally employed by those of ordinary skill in the art, such as solution polymerization and emulsion polymerization. The acrylic polymer comprises, as a main component, alkyl acrylate such as butyl acrylate, 2-ethylhexyl acrylate and the like and alkyl methacrylate such as butyl methacrylate, 2-ethylhexyl methacrylate and the like. For polymerization to obtain such an acrylic polymer, a solvent such as toluene, ethyl acetate and the like, and a polymerization initiator such as benzoyl peroxide, azobisisobutyronitrile and the like are preferably used. Such acrylic polymer used preferably has a weight average molecular weight of 150,000-1,000,000, more preferably 250,000-800,000.

The aforementioned polyacrylate adhesive may be prepared by adding various additives as necessary to the acrylic polymer.

The aforementioned acrylic polymer may be a copolymer of a monomer mixture containing, as necessary, alkyl acrylate or alkyl methacrylate and at least one monomer from 2-hydroxyethyl acrylate, 2-hydroxyethyl methacrylate, acrylic acid, methacrylic acid, styrene and vinyl acetate as a copolymerizable modifying monomer. In this copolymerization, a solvent such as toluene, ethyl acetate and the like, and a polymerization initiator such as benzoyl peroxide, azobisisobutyronitrile and the like, are preferably used. The release property of the sheet material and the pressure-sensitive adhesive layer can be further improved by the use of a polyacrylate pressure-sensitive adhesive prepared from the above-mentioned acrylic copolymer, for forming the pressure-sensitive adhesive layer.

While the pressure-sensitive adhesive suitable for forming the aforementioned pressure-sensitive adhesive layer may take any form during the preparation process, a solution, emulsion or hot melt is preferable for convenient handling. In addition, the pressure-sensitive adhesive may be used alone, as long as it is within the scope of the present invention or as long as the adhesive property as a pressure-sensitive adhesive is not impaired. Alternatively, it may be used as a mixture prepared by a conventionally known mixing method or stirring method.

A pressure-sensitive adhesive sheet comprising the sheet material of the present invention and a pressure-sensitive adhesive layer preferably comprises a support in contact with the side opposite from the side in contact with the sheet material of the pressure-sensitive adhesive layer. The support has a thickness of 30 μm-300 μm, preferably 50 μm-200 μm. Examples of the support include plastic film, metal foil, paper and the like. Examples of the plastic film include those made from high density polyethylene, low density polyethylene, linear low density polyethylene, polyester, polypropylene, poly-4-methyl-1-pentene, polystyrene, polyvinyl chloride and the like. Examples of the metal foil include aluminum foil and stainless foil. Examples of the paper include Japanese paper, kraft paper, woodfree paper and crepe paper. As the support, those mentioned above may be used alone or a laminate of those mentioned above may be used.

The pressure-sensitive adhesive sheet having a support can be prepared by, for example, forming a pressure-sensitive adhesive layer on one surface of the support, forming a sheet material on one surface of the release sheet substrate, and adhering these such that the pressure-sensitive adhesive layer comes into contact with the sheet material. It is also possible to directly apply a pressure-sensitive adhesive to a sheet material, dry the adhesive to form a pressure-sensitive adhesive layer, and adhere a support to a side opposite from the side of the pressure-sensitive adhesive layer that comes into contact with the sheet material.

The pressure-sensitive adhesive sheet of the present invention may have a laminate structure of a pressure-sensitive adhesive layer and a sheet material on both surfaces of the support. In other words, the pressure-sensitive adhesive sheet may have a pressure-sensitive adhesive layer in contact with both surfaces of the support, and a single layer or laminate sheet material in contact with each pressure-sensitive adhesive layer.

The pressure-sensitive adhesive sheet of the present invention may have a structure wherein, for example, a pressure-sensitive adhesive layer is in contact with one surface of a support, and one surface of a release sheet material or the outermost layer of a laminate sheet material is in contact with the other surface (back) of the support. With this construction, a pressure-sensitive adhesive sheet superior in the release properties from the backside can be produced.

The structure of the pressure-sensitive adhesive sheet having the sheet material of the present invention is also suitable for a pressure-sensitive adhesive tape. Accordingly, a pressure-sensitive adhesive sheet having the sheet material of the present invention may be realized as a pressure-sensitive adhesive tape having adhesive layers on both sides or a pressure-sensitive adhesive tape superior in the release property from the backside.

The present invention is explained in more detail in the following by referring to Examples. It should be noted that the present invention is not limited by these Examples.

### EXAMPLE 1

A resin material containing a linear ethylene resin, ethylene-1-hexene copolymer (J-REX LL AC41SA, JAPAN POLYOLEFINS CO., LTD.), was extrusion formed from a φ40 single screw knead-extruder at an extrusion temperature of 200° C. to give a 100 μm thick release sheet as a single layer sheet material. Using a cross fraction chromatographic apparatus (CFC T-150A, MITSUBISHI CHEMICAL CORPORATION) and following the aforementioned steps, the amount of the eluted component in the entire resin at not more than 30° C. was measured according to the Temperature Rising Elution Fractionation method. As a result, the amount was 7.8 wt %.

n-Butyl acrylate (100 parts by weight) and acrylic acid (5 parts by weight) were polymerized using toluene as a solvent and according to the method generally employed by those of ordinary skill in the art. As the polymerization initiator, benzoyl peroxide was used. By the polymerization reaction, a solution of acrylic polymer (solid content: 30%) having a weight average molecular weight of 500,000 was obtained. A melamine crosslinking agent (1.5 parts by weight) and an isocyanate crosslinking agent (3 parts by weight) per 100 parts by weight of the acrylic polymer were added to the acrylic polymer to give a polyacrylate pressure-sensitive adhesive.

The polyacrylate pressure-sensitive adhesive was applied to one surface of a 25 μm thick polyester film (support) in a thickness that makes the thickness after drying 30 μm, and dried at 120° C. for 3 min to give a pressure-sensitive adhesive layer. A sheet material was adhered to one surface of the pressure-sensitive adhesive layer thus formed to give a pressure-sensitive adhesive sheet.

### EXAMPLE 2

Liquid polycarbonate diol (PLACCEL CD-220PL, DAICEL CHEMICAL INDUSTRIES, LTD., hydroxyl value: 56.1 KOHmg/g, 250 parts by weight), sebacic acid (26.6 parts by weight) and titanium tetraisopropoxide (0.1 part by weight) (hereinafter to be referred to as TPT) as a catalyst was cast in a four neck separable flask equipped with a stirrer, a thermometer and a water separator. The mixture was stirred in the presence of a small amount of toluene and xylene as a solvent to discharge water from the reaction, and heated to 180° C., at which temperature the reaction mixture was maintained. After a while, liquefaction in a separator of water evaporated by high temperature heat occurred and the reaction started to proceed. The reaction was continued for about 25 hours and a solution of a polyester polymer having a weight average molecular weight of 38,000 was obtained.

Separately, 2-ethylhexyl acrylate (50 parts by weight), ethyl acrylate (50 parts by weight), methyl methacrylate (5 parts by weight) and 2-hydroxyethyl acrylate (4 parts by weight) were subjected to solution polymerization by a conventional method using toluene as a solvent and benzoyl peroxide (0.2 part by weight) as an initiator to give a solution of acrylic polymer having a weight average molecular weight of 450,000.

Then, a solution of the above-mentioned polyester polymer and a solution of the acrylic polymer were mixed such that 25 parts by weight of acrylic polymer solution is mixed with 75 parts by weight of the polyester polymer, and an adduct of trimethylolpropane with tolylene diisocyanate (coronate L, NIPPON POLYURETHANE INDUSTRY CO., LTD., 2.2 parts by weight) was added and mixed as a crosslinking agent to give a solution of a pressure-sensitive adhesive.

The obtained solution of the pressure-sensitive adhesive was applied to an aluminum foil surface of a laminate substrate (support) made of a polyethylene terephthalate sheet material (12 μm-30 μm) and dried at 120° C. for 3 min to give a pressure-sensitive adhesive layer having a thickness of 30 μm. The same sheet material as used in Example 1 was adhered to one surface of the pressure-sensitive adhesive layer to give a pressure-sensitive adhesive sheet.

### EXAMPLE 3

In the same manner as in Example 1 except that a release sheet prepared from a resin material containing an ethylene-1-octene copolymer (MORETEC 0218CN, Idemitsu Petrochemical Co., Ltd.), which was a linear ethylene resin, was used as a single layer sheet material, a pressure-sensitive adhesive sheet was prepared. In the same manner as in Example 1, the amount of the eluted component in the entire resin at not more than 30° C. was measured according to the Temperature Rising Elution Fractionation method. As a result, the amount was 4.8 wt %.

### EXAMPLE 4

In the same manner as in Example 2 except that the sheet material obtained in Example 3 was used, a pressure-sensitive adhesive sheet was prepared.

### EXAMPLE 5

In the same manner as in Example 1 except that a release sheet prepared from a linear ethylene resin (MORETEC 1018D, Idemitsu Petrochemical Co., Ltd.), which is an ethylene-1-octene copolymer containing low density polyethylene at a concentration of 20%, as a sheet material of a single layer, a pressure-sensitive adhesive sheet was prepared. The amount of the eluted component in the entire resin at not more than 30° C. was measured according to the Temperature Rising Elution Fractionation method as in Example 1. As a result, the amount was 5.4 wt %.

### EXAMPLE 6

A curing accelerator (CAT HY-91, Toyo-Morton, Ltd., 7 parts by weight) was added to an ester urethane anchor coat agent (AD-527, Toyo-Morton, Ltd., 100 parts by weight) and ethyl acetate was added to make the solid concentration 30 wt % to give an anchor coat agent solution. This solution was applied to a 50 μm thick polyethylene terephthalate film (Lumirror S-27-50, Toray Industries, Inc.) with a Mayer-bar #6 and dried at 80° C. for 90 seconds to form an anchor coat layer. The same release sheet as in Example 1 except the thickness of 25 μm was adhered to this anchor coat layer to give a laminate sheet material.

The same pressure-sensitive adhesive layer as used in Example 1 was adhered to the sheet material so that it is in contact with a release sheet to give a pressure-sensitive adhesive sheet.

### COMPARATIVE EXAMPLE 1

In the same manner as in Example 1 except that a release sheet prepared from a resin material comprising an ethylene-1-hexene copolymer (Evolue SP0540, Mitsui Chemicals, Inc.), which is a linear ethylene resin, a pressure-sensitive adhesive sheet was prepared. The amount of the eluted component in the entire resin at not more than 30° C. was measured according to the Temperature Rising Elution Fractionation method as in Example 1. As a result, the amount was 2.8 wt %.

### COMPARATIVE EXAMPLE 2

In the same manner as in Example 1 except that a release sheet prepared from a resin material containing an ethylene-1-hexene copolymer (Evolue SP1540, Mitsui Chemicals, Inc.), which is a linear ethylene resin, was used as a single layer sheet material, a pressure-sensitive adhesive sheet was prepared. The amount of the eluted component in the entire resin at not more than 30° C. was measured according to the Temperature Rising Elution Fractionation method as in Example 1. As a result, the amount was 1.0 wt %.

### COMPARATIVE EXAMPLE 3

In the same manner as in Example 2 except that a release sheet prepared from a resin material containing an ethylene-1-octene copolymer (DOWLEX 2045AC, The Dow Chemical Company), which is a linear ethylene resin, was used as a single layer sheet material, a pressure-sensitive adhesive sheet was prepared. The amount of the eluted component in the entire resin at not more than 30° C. was measured according to the Temperature Rising Elution Fractionation method as in Example 1. As a result, the amount was 1.8 wt %.

### COMPARATIVE EXAMPLE 4

In the same manner as in Example 6 except that the same linear ethylene resin as used in Comparative Example 3, a pressure-sensitive adhesive sheet having a laminate sheet material was prepared.

<Release property test>

The pressure-sensitive adhesive sheets prepared in

Examples 1-6 and Comparative Examples 1-4 were cut into 20 mm wide specimens (n=3) and peeling strength of each sample was measured. The sheet material side of these samples was adhered to a plate having rigidity and the support side thereof was pulled with a universal tensile strength tester (RTM-100, KK Orientech), and resistance, or peeling strength, of each sample was measured by a known test method of 180° angle peeling test. The aforementioned test was performed at temperature 23° C. and 60% RH at crosshead speed of the universal tensile strength tester of 300 mm/min.

The results are shown in Table 1.

TABLE 1

| | amount of eluted component [wt %] at | peeling |
|---|---|---|
| | 30° C. or below by Temperature Rising | strength [N/20 |
| | Elution Fractionation method | mm width] |
| Example 1 | 7.8 | 0.18 |
| Example 2 | 7.8 | 0.11 |
| Example 3 | 4.8 | 0.12 |
| Example 4 | 4.8 | 0.15 |
| Example 5 | 5.4 | 0.21 |
| Example 6 | 7.8 | 0.11 |
| Comparative | 2.8 | 2.02 |
| Example 1 | | |
| Comparative | 1.0 | 1.42 |
| Example 2 | | |
| Comparative | 1.8 | 0.62 |
| Example 3 | | |
| Comparative | 1.8 | 0.64 |
| Example 4 | | |

As is evident from the results in Table 1 above, a single layer or laminate pressure-sensitive adhesive sheets of Examples 1-6 having the sheet material of the present invention prepared from a resin material having property values within specific ranges showed a low peeling strength of not more than 0.25 N/20 mm width, and showed superior release properties. Therefrom it is apparent that the sheet material of the present invention can be effectively used for a pressure-sensitive adhesive sheet superior in release properties. In contrast, the pressure-sensitive adhesive sheets of Comparative Examples 1-4 having a sheet material prepared using a resin material different from that used in the present invention showed considerably large peeling strength, posing various problems.

The foregoing description clearly establishes that the present invention provides a pressure-sensitive adhesive sheet superior in release property of a sheet material and a pressure-sensitive adhesive layer, and a sheet material having a release function suitable for the sheet.

This application is based on patent application No. 2000-342521 filed in Japan, the contents of which are hereby incorporated by reference.

What is claimed is:

1. A single layer or laminate sheet material having a release function for a pressure-sensitive adhesive sheet, wherein the sheet material itself when it is a single layer, and at least one of the outermost layers when it is a laminate, is made from a resin material comprising a linear ethylene resin as a main component, and the resin material shows an amount of an eluted component at not more than 30° C. of 3 wt %-30 wt % of the entire resin material, as measured by a Temperature Rising Elution Fractionation method.

2. The sheet material of claim 1, wherein the linear ethylene resin is a copolymer of ethylene and at least one kind of a comonomer selected from a-olefins having 3 to 12 carbon atoms.

3. A pressure-sensitive adhesive sheet comprising the sheet material of claim 1 or 2 and a pressure-sensitive adhesive layer formed to be in contact with the sheet material itself when it is a single layer or, when it is a laminate, at least an outermost layer thereof made from a resin material comprising a linear ethylene resin as a main component.

4. The pressure-sensitive adhesive sheet of claim 3, wherein the pressure-sensitive adhesive layer is formed using, as a main component, a polyester adhesive comprising aliphatic polycarbonate diol as an essential polyol component.
